(19) United States
(12) Patent Application Publication
(10) Pub. No.: US 2016/0249667 A1
(43) Pub. Date: Sep. 1, 2016

(54) Multipurpose Moisture-Preserving Raw Lobster Products Formed From Intact Tail Slices and Methods For Manufacturing Same

(71) Applicant: Alison W. Barshak, Atlanta, GA (US)

(72) Inventor: Alison W. Barshak, Atlanta, GA (US)

(21) Appl. No.: 15/040,374

(22) Filed: Feb. 10, 2016

Related U.S. Application Data
(63) Continuation of application No. PCT/US2016/016236, filed on Feb. 2, 2016.
(60) Provisional application No. 62/086,329, filed on Dec. 2, 2014.

(51) Int. Cl. A23L 1/31; A23B 4/06

(52) U.S. Cl. CPC A23L 1/3257; A23L 1/33; A23B 4/066; A23V 2002/00

(57) ABSTRACT

A raw lobster product including a sealing material that has at least one carbohydrate, and an intact widthwise slice of raw lobster tail meat removed from a lobster tail and devoid of shell or exoskeleton. The slice of raw lobster tail meat is compressed by application of force to have, relative to its state at the time of removal from the lobster tail, both (i) a reduced thickness and (ii) at least one of an increased length and an increased width. The sealing material covers at least a portion of the surface of the slice of raw lobster tail meat.

### CROSS-REFERENCE TO RELATED APPLICATIONS

This application is a continuation of International Application No. PCT/US2016/16236, filed Feb. 2, 2016, which claims priority to U.S. Provisional Patent Application Ser. No. 62/086,329, filed Dec. 2, 2014, the disclosures of both of which are incorporated herein by reference in their entirety.

### BACKGROUND

1. Technical Field

The present disclosure relates, generally, to shellfish, and more particularly, to the processing and cooking of lobster.

2. Description of the Related Art

Lobster tail has conventionally been an expensive, extremely-perishable, and labor-intensive luxury item that can be difficult to cook and prepare properly.

When lobster is being prepared, avoiding loss of moisture is important. Removing a lobster tail from its shell prior to cooking tends to result in moisture loss during cooking, because the moisture-retaining properties of the shell are lost. Additionally, cutting a lobster tail out of the shell with a knife or similar implement causes holes and cuts in the outer surface of the tail, which promotes moisture to escape. Lobster tail meat, including whole lobster tail, is typically delivered to consumers in either frozen raw or cooked form, because fresh raw lobster meat perishes quickly. Every time a frozen product is thawed and additionally processed, temperature “abuse” (which is cumulative from the time of catching/harvest to the time of consumption) results, affecting the freshness and shelf life of the product. Additionally, during the process of cooking or reheating, lobster meat loses moisture. This loss is exacerbated by reheating pre-cooked lobster meat.

Although individual smaller pieces of lobster meat have been conventionally assembled into “cakes,” “burgers,” “patties,” and the like, these products rely on preserving moisture by agglomerating a large number of small pieces to protect inner pieces from moisture loss. During assembly, the individual pieces of meat, which are generally pre-cooked, experience loss of moisture due to substantial exposed surface area until they are assembled into a larger mass. Binders, meat glues, and filler materials are typically used to fuse pieces together, diluting and detracting from the flavor, consistency, and other characteristics that lobster naturally has.

However, no conventional product involves the use of only a single intact portion of lobster meat. Preparing and serving a single intact portion of lobster meat, other than an entire tail, has conventionally been impractical, because of significant resulting moisture loss.

Since lobster meat is relatively expensive, lobster tails are normally prepared whole, because keeping the tail whole has conventionally maximized value by weight, whereas breaking the tail into smaller portions has conventionally devalued the final product by weight.

### SUMMARY

Embodiments of the disclosure provide a lobster product made using an intact sliced cross-sectional portion of raw lobster tail meat. The product can be used in a wide variety of recipes, e.g., in lieu of a chicken, pork, or veal cutlet. In one embodiment, lobster tail is brought to a temperature slightly above freezing, then sliced, and pounded or fed through a rolling mechanism. The resulting flattened meat is then seasoned and coated with flour, egg, and bread, and is then thoroughly frozen.

Different variations of methods for producing a lobster product may be used in different embodiments of the disclosure, and those methods may depend, e.g., on lobster volume, tail size, and production/recipe specifications.

In one embodiment, the disclosure provides a raw lobster product including a sealing material that has at least one carbohydrate, and an intact widthwise slice of raw lobster tail meat removed from a lobster tail and devoid of shell or exoskeleton. The slice of raw lobster tail meat is compressed by application of force to have, relative to its state at the time of removal from the lobster tail, both (i) a reduced thickness and (ii) at least one of an increased length and an increased width. The sealing material covers at least a portion of the surface of the slice of raw lobster tail meat.

In another embodiment, the disclosure provides a method for manufacturing a raw lobster product. The method includes: removing an intact widthwise slice of raw lobster tail meat from a lobster tail, wherein the slice of raw lobster tail meat is devoid of shell or exoskeleton; compressing the slice of raw lobster tail meat by application of force to have, relative to its state at the time of removal from the lobster tail, both (i) a reduced thickness and (ii) at least one of an increased length and an increased width; and covering at least a portion of the surface of the slice of raw lobster tail meat with a sealing material comprising at least one carbohydrate.

### BRIEF DESCRIPTION OF THE DRAWINGS

FIG. 1 shows a raw lobster tail removed from its shell by high-pressure processing (HPP) techniques, in one embodiment of the disclosure;

FIG. 2 shows a step of the raw lobster tail of FIG. 1 being divided widthwise into cross-sectional raw slices at an approximately 90 degree cutting angle relative to the cutting surface, in one embodiment of the disclosure;

FIG. 3 shows a step of the raw lobster tail of FIG. 1 being divided widthwise into cross-sectional raw slices at an approximately 30 degree cutting angle relative to the cutting surface, in one embodiment of the disclosure;

FIG. 4 shows a detailed view of the lobster tail of FIG. 1 with a cross-sectional raw slice removed according to the method shown in FIG. 3, in one embodiment of the disclosure;

FIG. 5 shows a step of placing the raw lobster tail slice of FIG. 4 under plastic wrap, in one embodiment of the disclosure;

FIG. 6 shows a step of compressing the raw lobster tail slice of FIG. 4 using a meat mallet, in one embodiment of the disclosure;

FIG. 7 shows a step of coating the compressed raw lobster tail slice of FIG. 6 with flour, in one embodiment of the disclosure;

FIG. 8 shows a detailed view of a coated raw lobster tail slice produced by the step shown in FIG. 7, in one embodiment of the disclosure;

FIG. 9 shows a step of bathing the coated raw lobster tail slice of FIG. 8 in egg, in one embodiment of the disclosure;

FIG. 10 shows a step of breading the egg-bathed raw lobster tail slice of FIG. 9, in one embodiment of the disclosure;

FIG. 11 shows a detailed view of a multipurpose moisture-preserving raw lobster product produced by the step shown in FIG. 10, in one embodiment of the disclosure;

FIG. 12 shows a step of sealing frozen the multipurpose moisture-preserving raw lobster product of FIG. 11 in a consumer retail package, in one embodiment of the disclosure;

FIG. 13 shows a step of pan-frying the multipurpose moisture-preserving raw lobster product of FIG. 11, in one embodiment of the disclosure;

FIG. 14 shows the multipurpose moisture-preserving raw lobster product of FIG. 11, pan-fried, fully-cooked, and on a plate for serving, in one embodiment of the disclosure; and

FIG. 15 shows the multipurpose moisture-preserving raw lobster product of FIG. 11, pan-fried, fully-cooked, and in a sandwich, in one embodiment of the disclosure.

### DETAILED DESCRIPTION

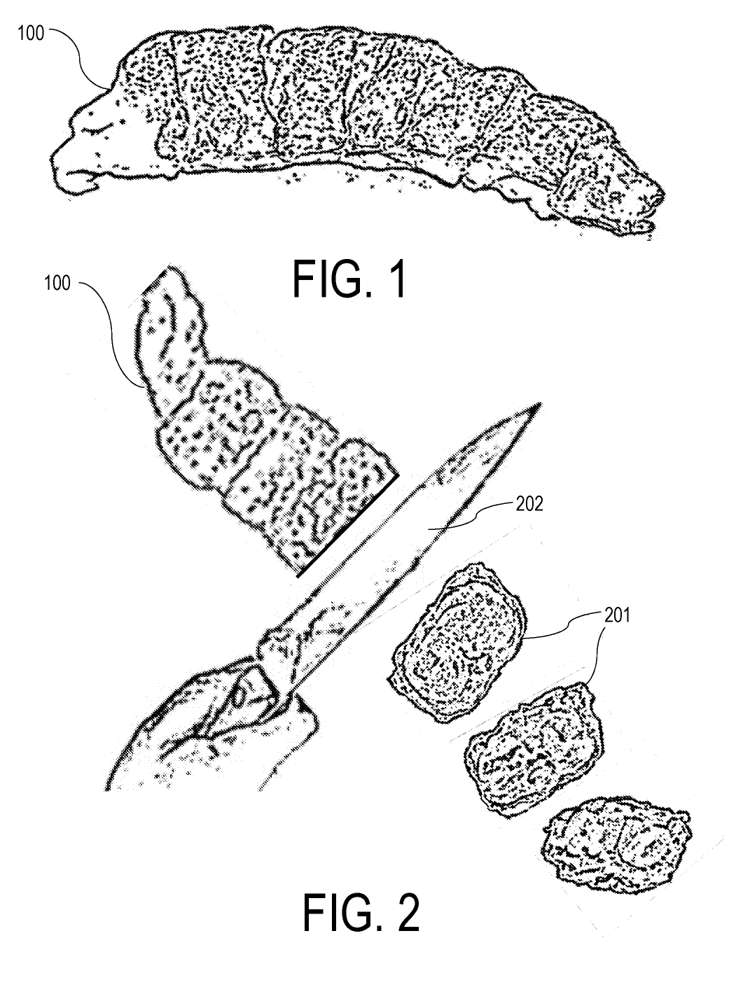

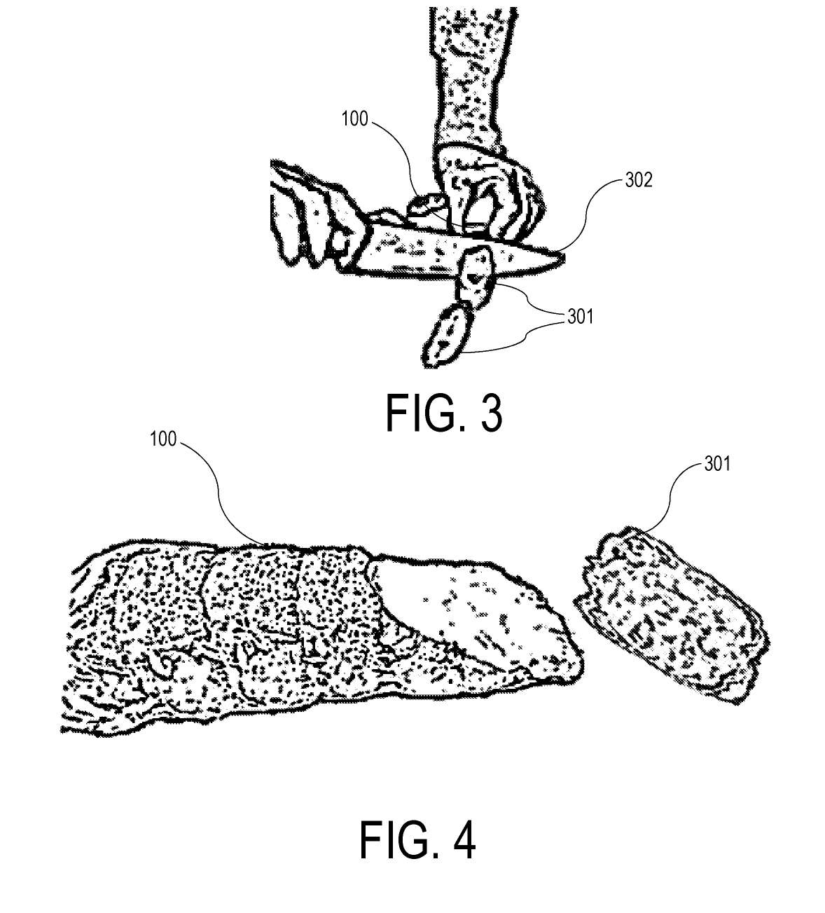

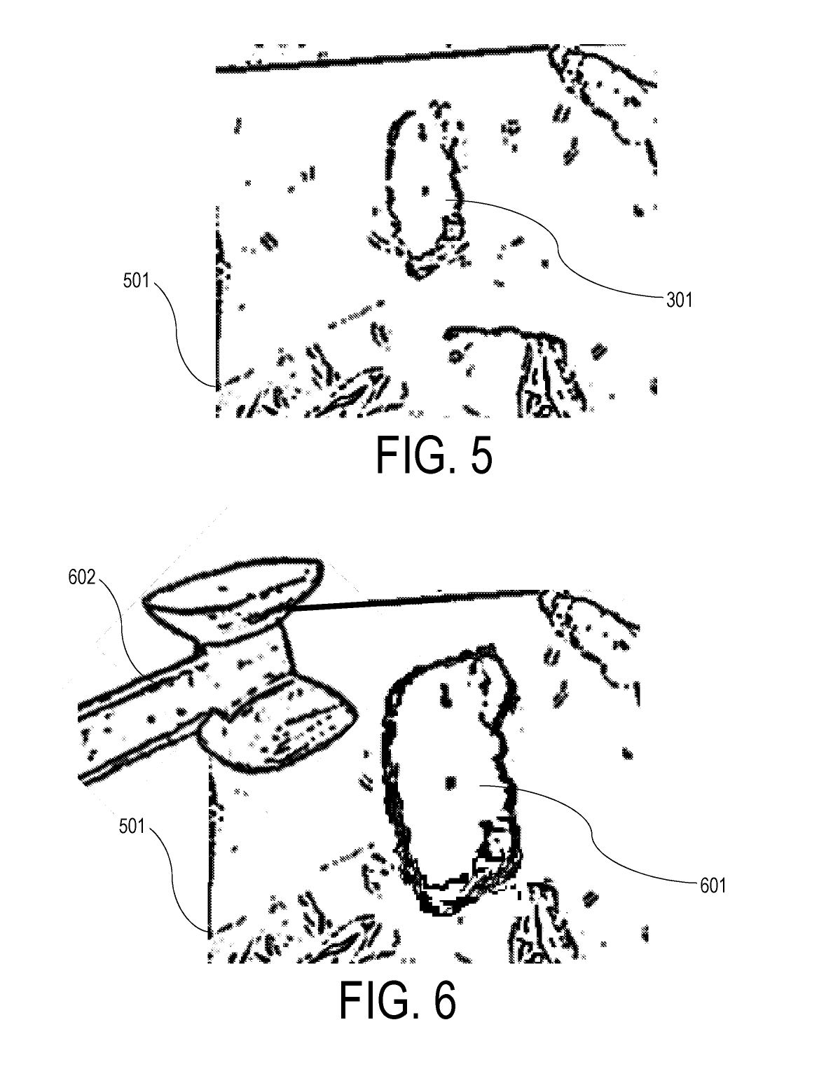

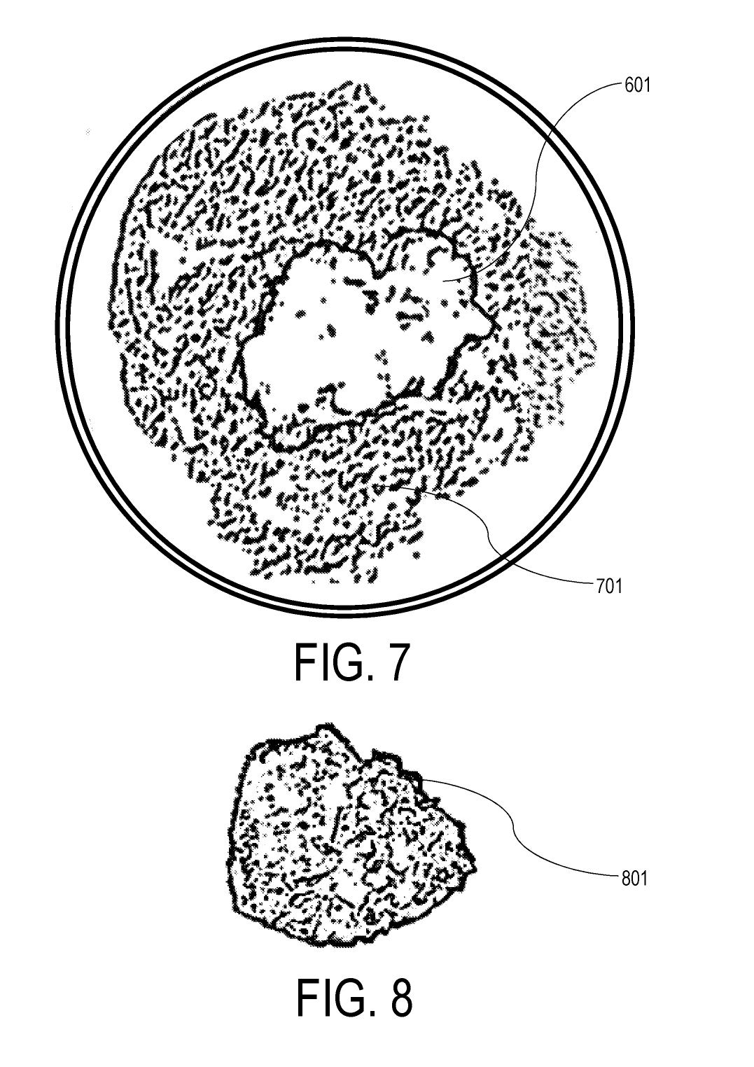

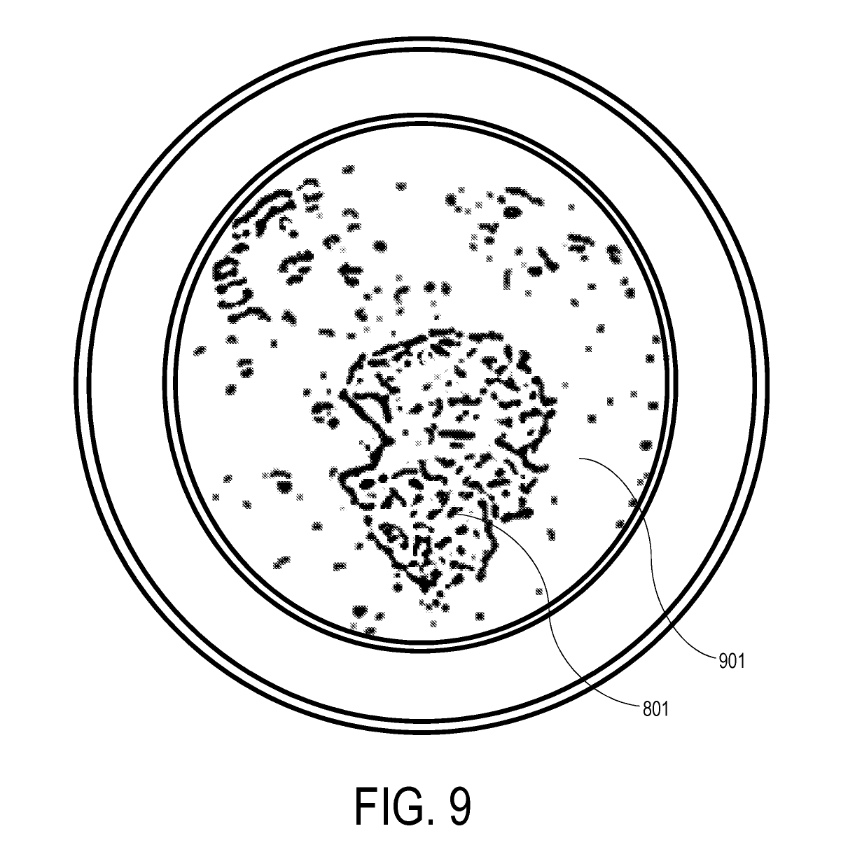

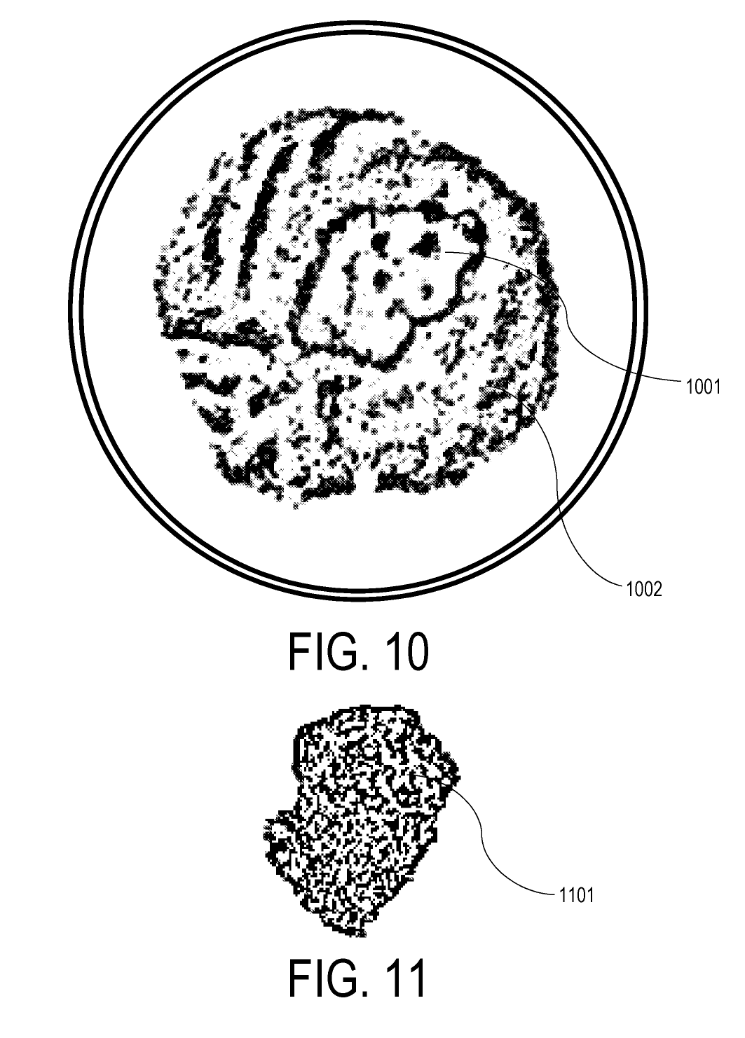

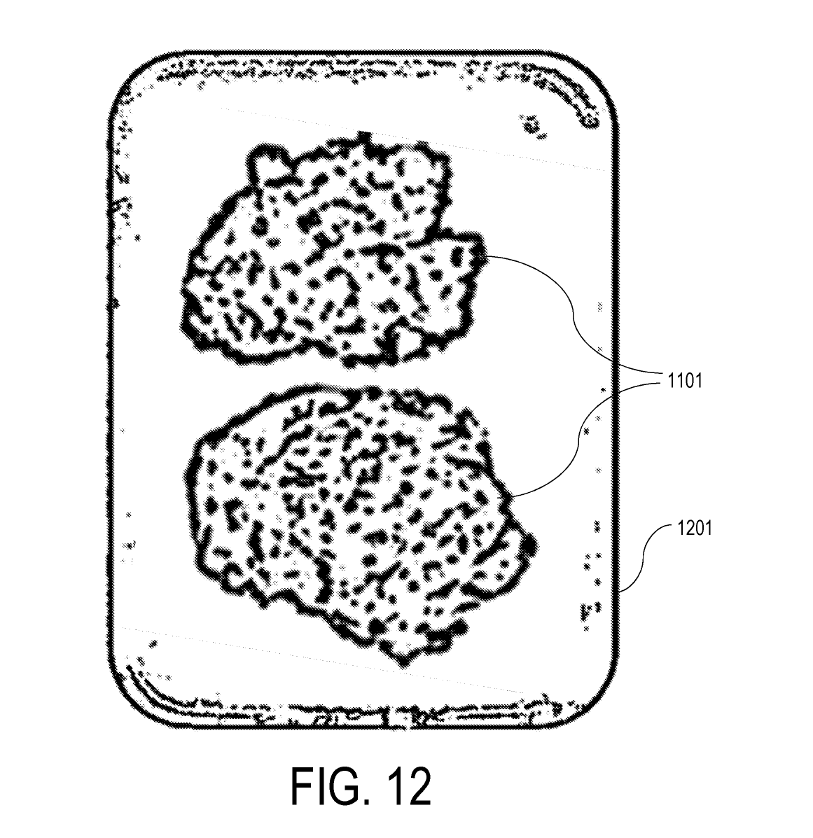

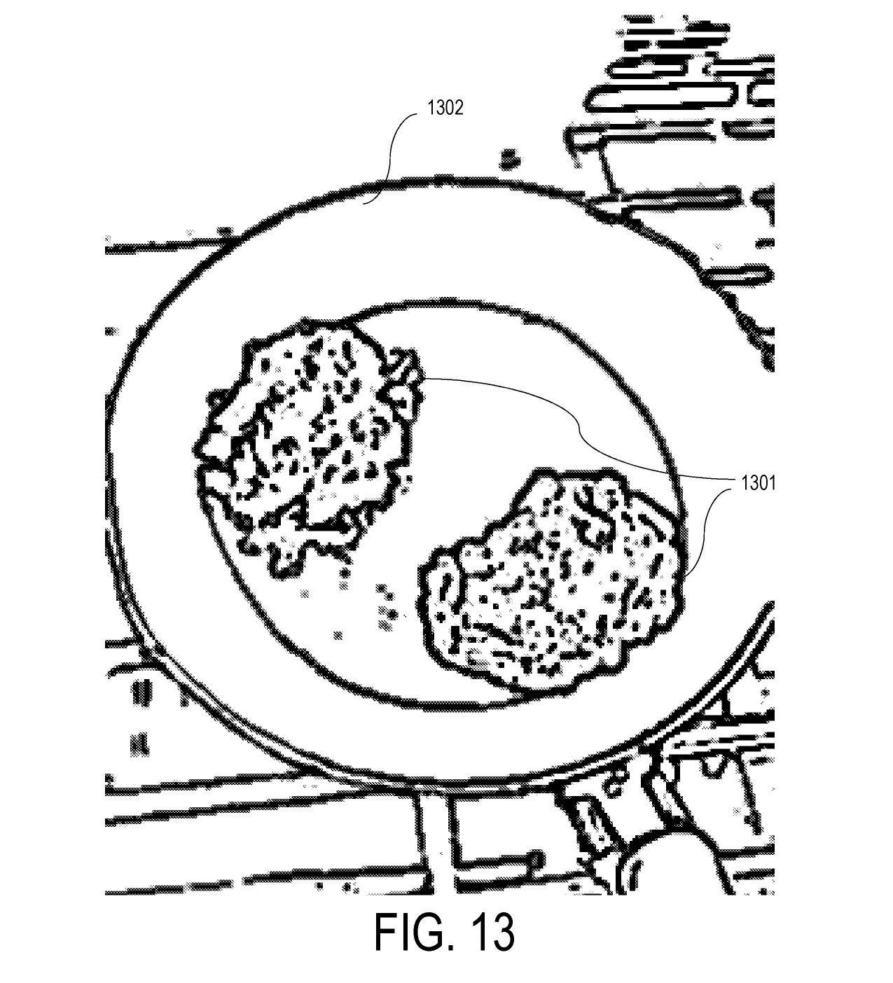

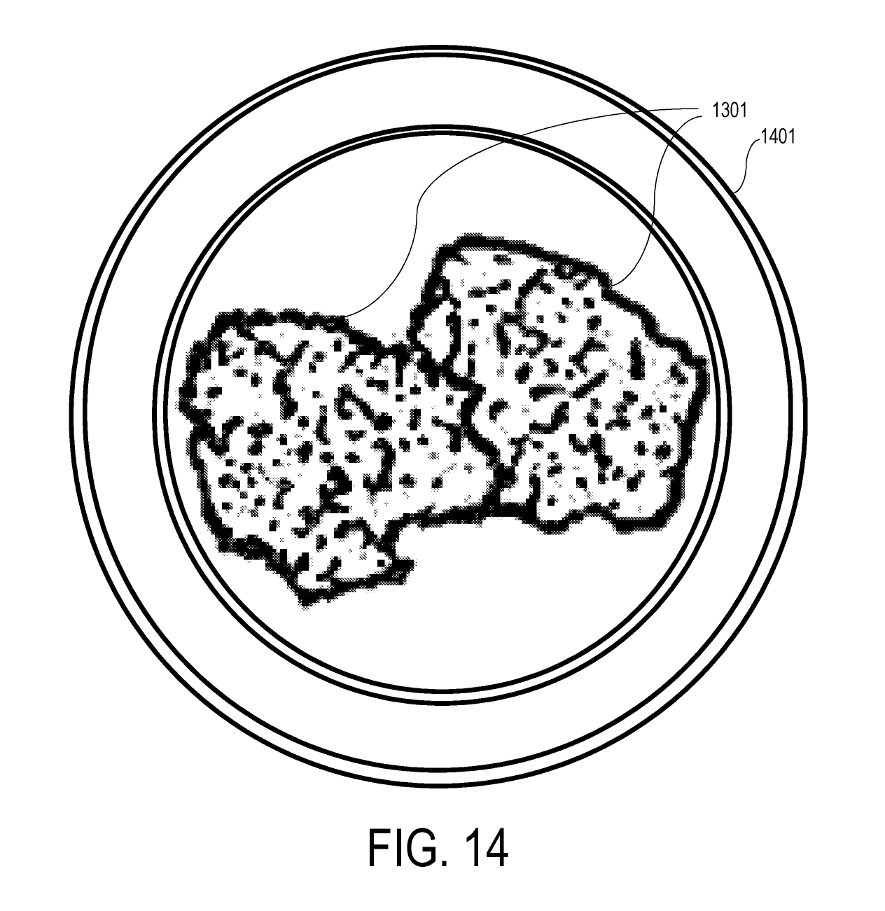

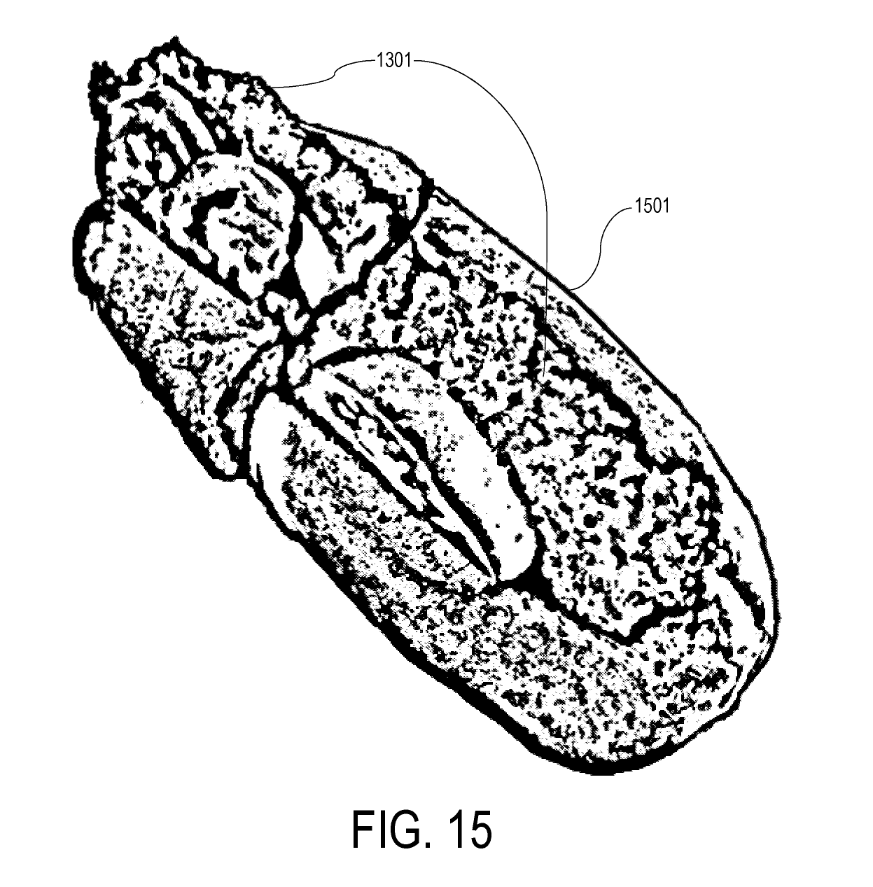

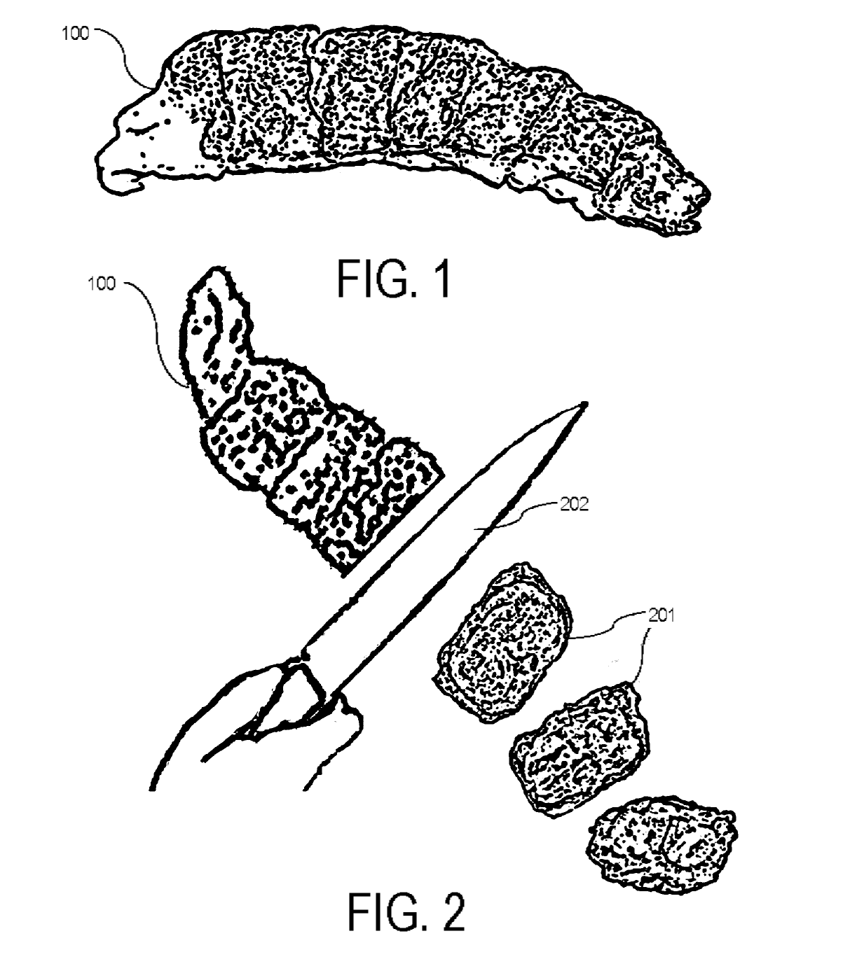

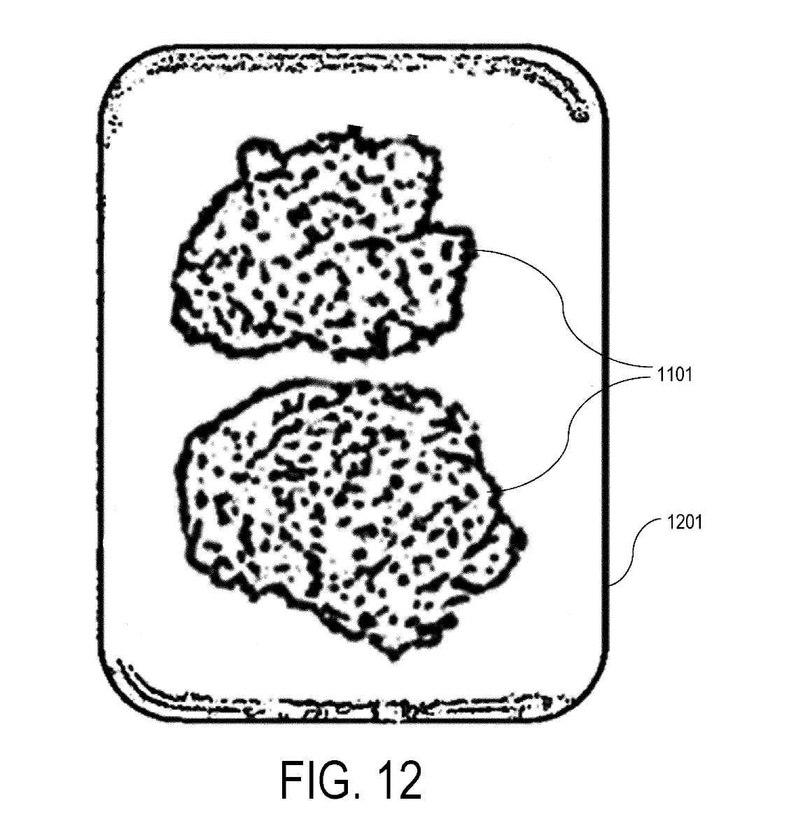

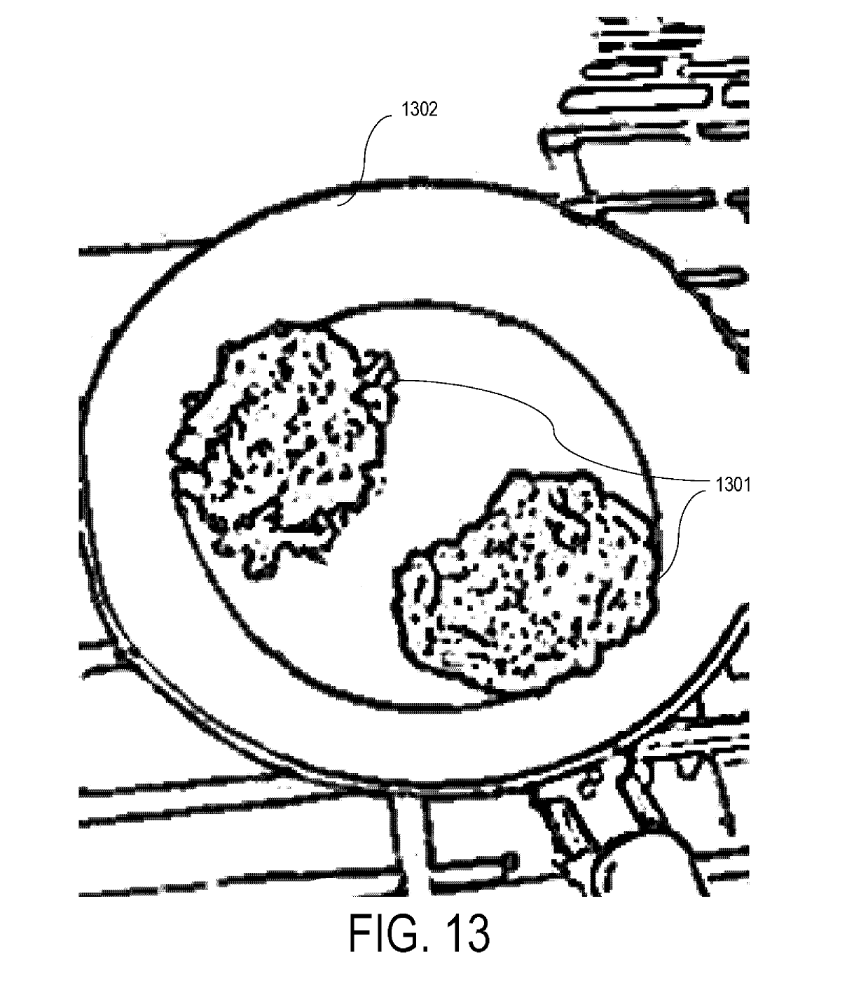

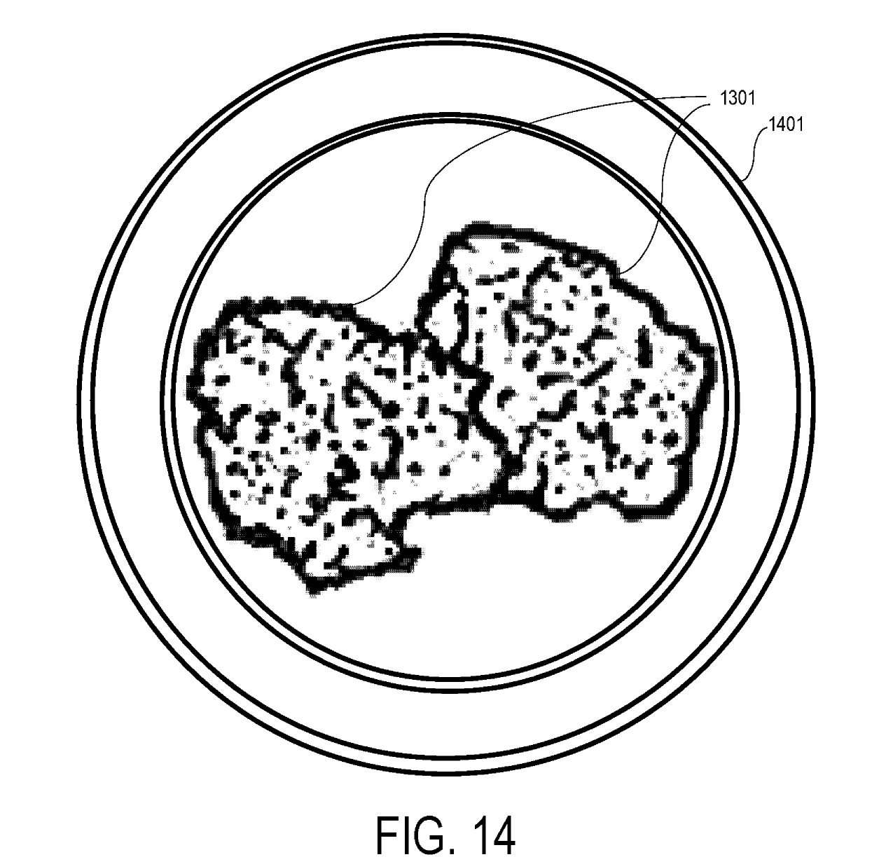

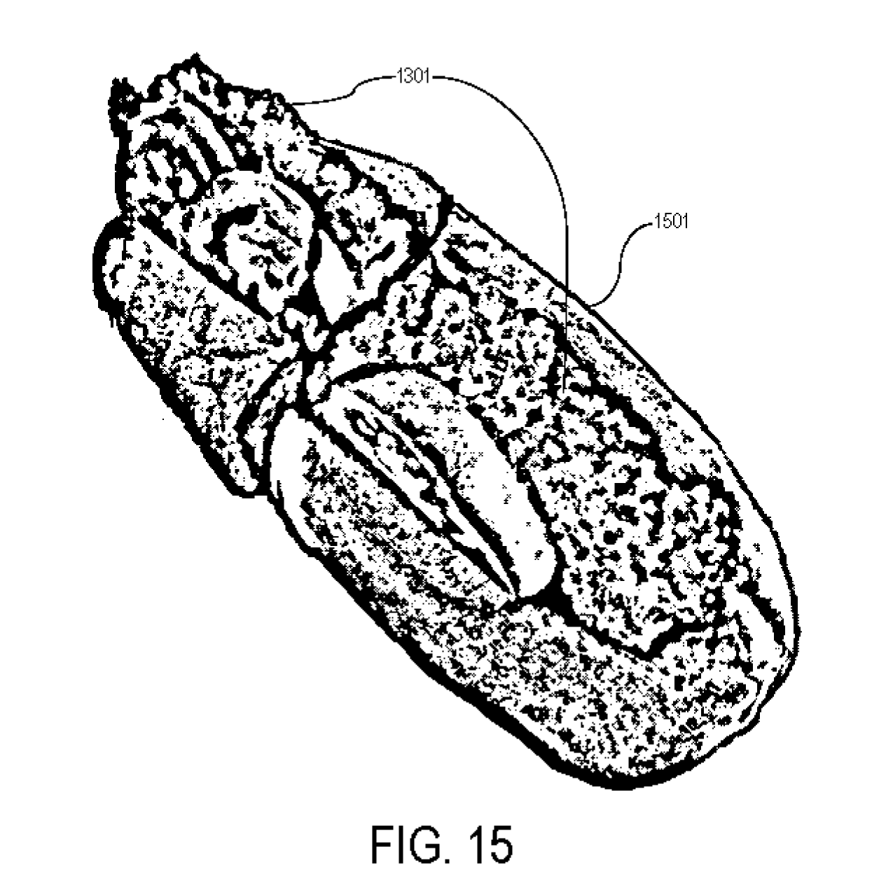

With reference now to FIGS. 1-11, an exemplary method for producing a multipurpose moisture-preserving raw lobster product formed from an intact tail slice is illustrated. An exemplary resulting packaged raw lobster product is shown in FIG. 12, which is shown in FIG. 13 during the cooking process and in FIGS. 14 and 15 in ready-to-eat form.

Turning first to FIG. 1, as an initial step in production, a raw intact lobster tail 100 is removed from its shell by high-pressure processing (HPP) techniques, in one exemplary embodiment of the disclosure. HPP techniques (also referred to as “pascalization”) separate lobster meat from the shell and exoskeleton, while inactivating dangerous foodborne microorganisms with high pressure. During the HPP process, a live lobster is loaded into a processing machine, which uses pressure at or above 40,000 pounds per inch (approximately 275790 KPa) to kill the lobster almost instantaneously, while also separating the meat inside the lobster from the shell, permitting shucking while the meat is raw. Because the pressure is equal from all sides and no heat is involved, the taste and texture of the lobster's meat is not degraded. After applying HPP, 100 percent of the lobster tail meat is easily removed intact. By employing HPP, moisture retention is improved because juices do not escape from the lobster meat during processing, cooking, or storage. The lobster tail can be removed by other techniques in alternative embodiments of the disclosure, such as cutting the tail meat out of the shell by hand, which can be extremely difficult to do without piercing the surface of the tail meat and risking the escape of juices.

Next, once lobster tail 100 has been removed from the shell, the tail may be frozen for storage and/or shipping prior to subsequent processing. Alternatively, the additional processing described below can take place without freezing the lobster tail. However, in either case, hand-cutting a raw lobster tail into slices can be difficult to perform without bringing the lobster tail to a near-freezing temperature, either by slightly defrosting a frozen HPP-processed lobster tail, or by chilling an ambient-temperature lobster tail. A slicing machine (e.g., blade, ultrasonic, laser, or the like) may be used to perform the cuts, in which cutting of the lobster tail may take place at a higher temperature. Cutting lobster tail meat that is too warm when cut risks smashing or otherwise degrading the delicate fibers of the meat. If the lobster meat is below freezing, then there is a risk of chipping or shattering the tail meat while cutting. Accordingly, lobster tail 100 is desirably brought to a temperature of between 32 and 45 degrees F. (approximately 0 to 7.2 degrees C.) to permit the tail meat to be rigid enough for cutting without.

Lobster tail 100 is then divided into slices, e.g., ½ to 1 ounce (approximately 14 to 28 grams) per slice. As shown in FIG. 2, in one exemplary embodiment, lobster tail 100 is divided widthwise (i.e., crosswise) by hand into cross-sectional raw slices 201 using a knife 202, at an approximately 90 degree cutting angle relative to the cutting surface. Although this cutting angle yields smaller slices having a relatively reduced length and width, cutting at or about a 90 degree angle can be readily accomplished with conventional meat-cutting or seafood-cutting equipment and can therefore reduce production cost and increase efficiency.

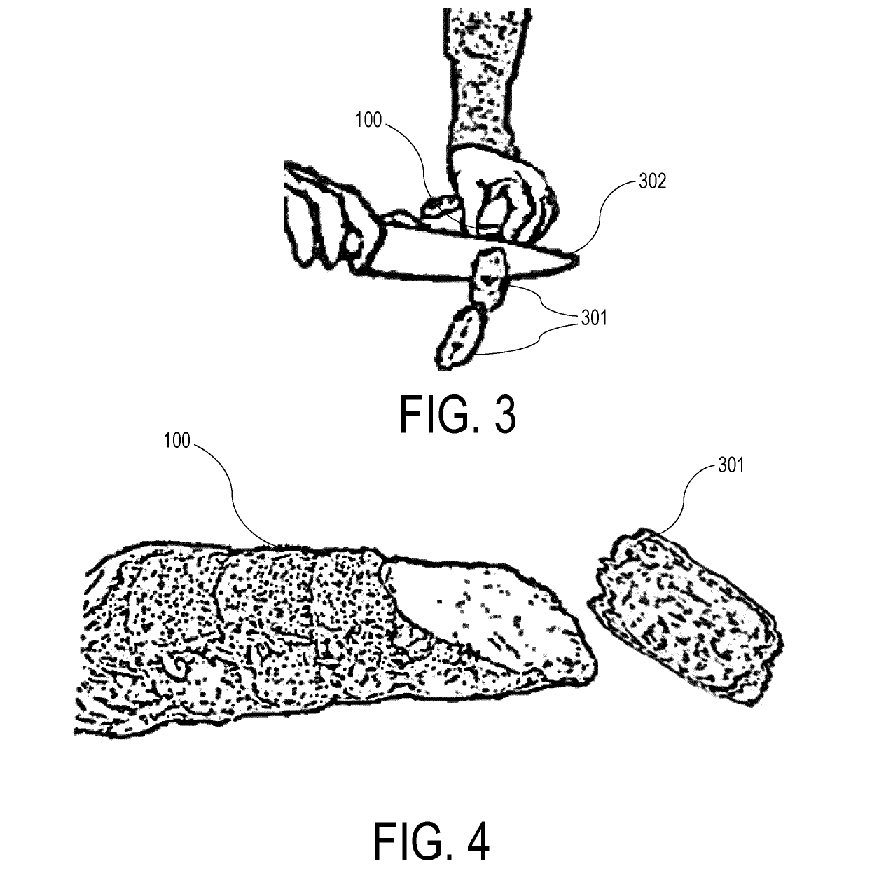

In an alternative embodiment, as FIG. 3 illustrates, lobster tail 100 is divided widthwise by hand into cross-sectional raw slices 301 using a knife 302, at an approximately 30 degree cutting angle relative to the cutting surface. FIG. 4 shows a more detailed view of lobster tail 100, with a cross-sectional raw slice 301 removed.

As the cutting angle decreases (e.g., in the range of between 10 degrees and 45 degrees relative to the cutting surface), the length of each slice increases, resulting in larger slices that create a larger final consumer product. Cutting tail sections widthwise yields generally round or oval-shaped slices, which are visually appealing. Cuts are desirably made at an angle of between 10 and 90 degrees relative to the cutting surface. Although lengthwise cuts and other directions and types of cuts are possible in alternative embodiments, the resulting product may be less aesthetically pleasing to the eye than generally round or oval-shaped products produced by crosswise slicing. Additionally, widthwise cutting yields the greatest number of uniformly-shaped and uniformly-sized slices per lobster tail, which simplifies mass production and enhances visual appeal.

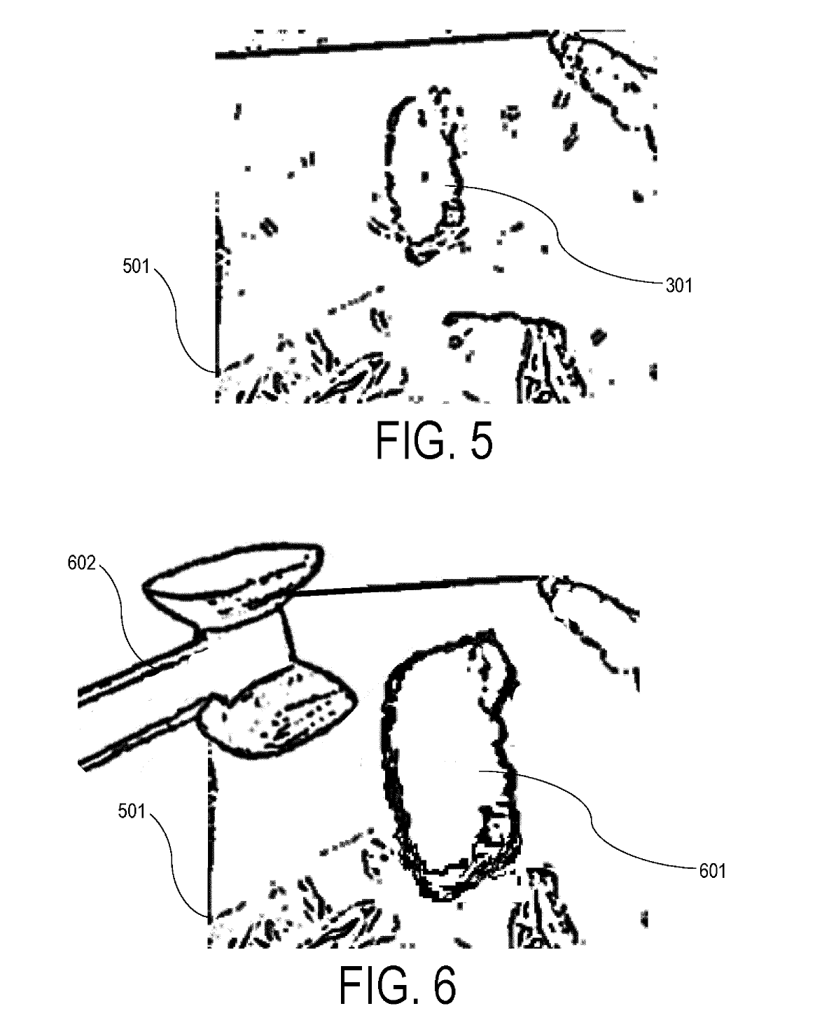

Next, raw slices 301 are compressed. Although alternative embodiments may employ manual or automated extrusion techniques (e.g., rollers) or the like to achieve compression, in this embodiment, raw slices 301 are manually pounded. First, as shown in FIG. 5, each raw slice 301 is placed under plastic wrap 501 (or parchment or the like). Next, as FIG. 6 illustrates, a meat mallet 602 is used to manually and evenly compress the raw slices 301 until flattened to desired dimensions. As shown, the result is a compressed raw slice 601 that has a reduction in thickness relative to raw slice 301, while having an increase in other dimensions, including width, length, perimeter, area of each flat side, and overall surface area.

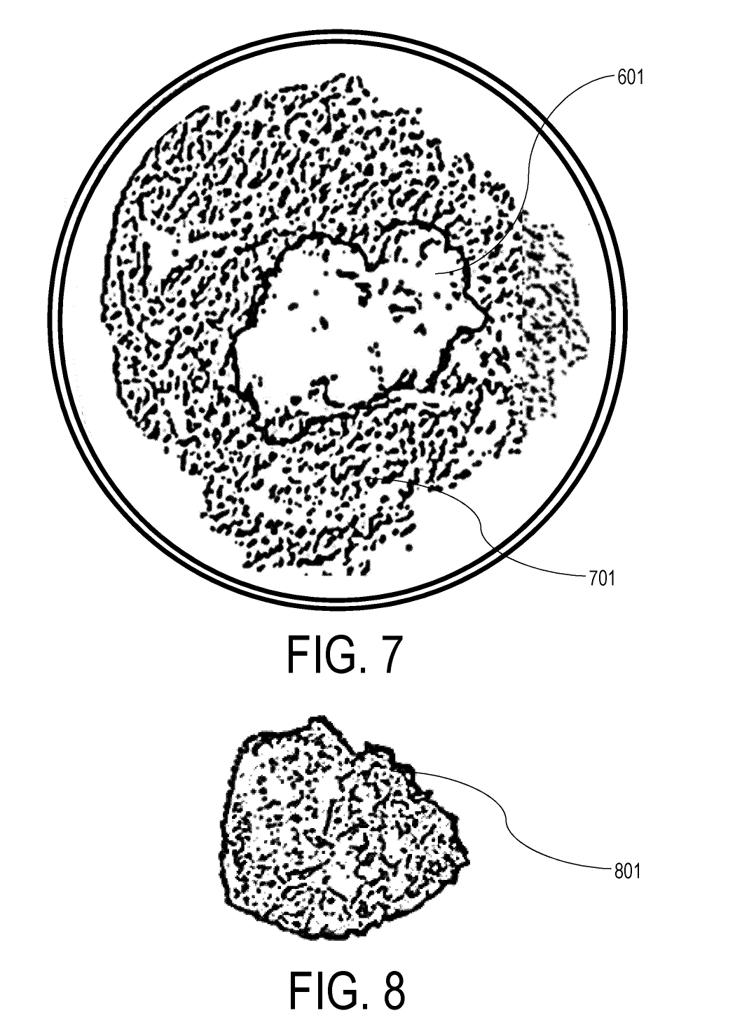

Compressed raw slice 601 is then coated with a sealing material, such as a carbohydrate, to seal within and prevent loss of internal moisture, and, in turn, preserves flavor and structural integrity. In this embodiment, as shown in FIGS. 7-10, a three-step carbohydrate-coating process (flour, egg, bread crumbs) is used, although, in other embodiments, single-step processes (e.g., dusting) and different multi-step processes for carbohydrate coating (e.g., battering) may be used. The carbohydrate-coating process desirably includes applying one or more powdered, crushed, crumbled, flaked, or other particulate forms of at least one carbohydrate to compressed raw slice 601. While other sealing materials are possible, carbohydrates are desirably used because of their ability to absorb a small amount of moisture from the surface of compressed raw slice 601 and seal the surface entirely to prevent loss of the remaining moisture within the lobster meat.

Various carbohydrates may be used for sealing purposes, including starches, sugars capable of forming a film, celluloses, dextrins, gums. One carbohydrate may be used, or multiple carbohydrates may be used, in different embodiments. Starches, including both raw and pregelatinized (i.e., dried, cooked starch) forms, are desirably used as carbohydrates for coating, both for their sealing functionality and for their flavoring characteristics. Starches and grains having starch-containing components that are used for sealing, in embodiments of the disclosure, may include one or more of the following exemplary ingredients: amaranth, buckwheat, corn, finger millet, job's tears, millet, montina, quinoa, rice, sorghum, tef, wild rice, arrowroot, beans (e.g., black, navy, pinto, soy, lentils) cassava, flax, nuts (e.g., almonds, walnuts, hazelnuts), peas, potatoes, sago, seeds, tapioca, yucca, bromated flour, bulgur, durum flour, enriched flour, farina, flour, gluten flour, graham flour, phosphated flour, plain flour, self-rising flour, semolina, and white flour.

FIG. 7 illustrates the first of three coating steps, namely, a step of coating compressed raw slice 601 with a first carbohydrate, flour 701. A detailed view of a coated raw lobster tail slice 801 produced by the step shown in FIG. 7, in one embodiment of the disclosure, is provided in FIG. 8.

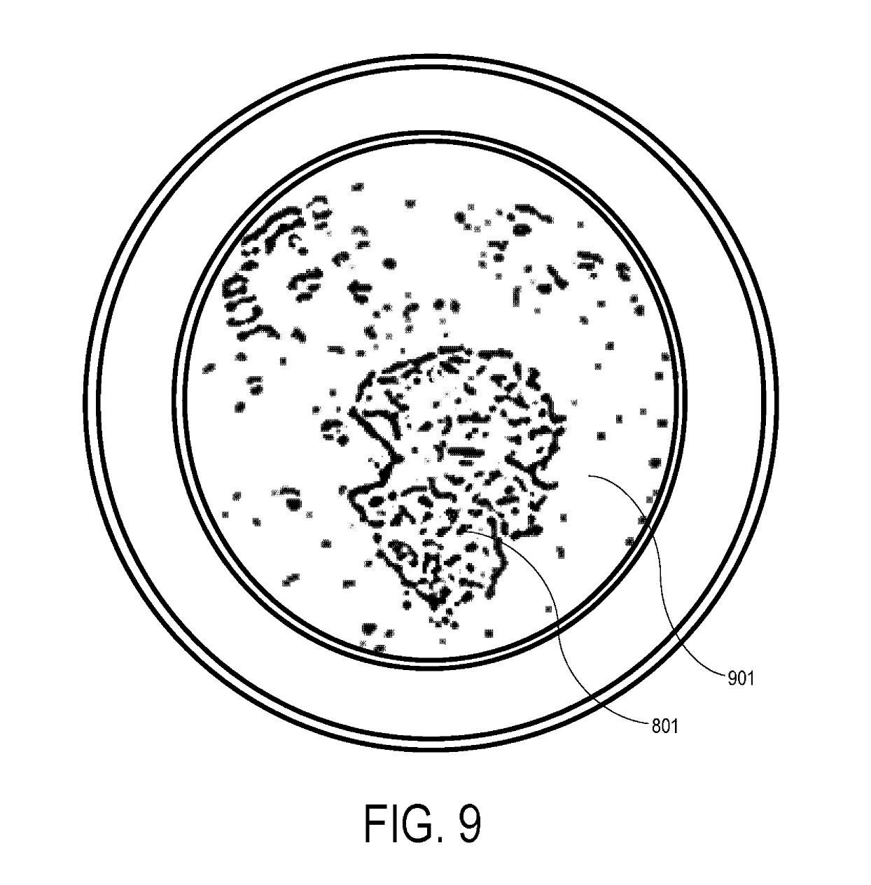

The second step entails bathing the coated raw lobster slice 801 in egg 901, as shown in FIG. 9.

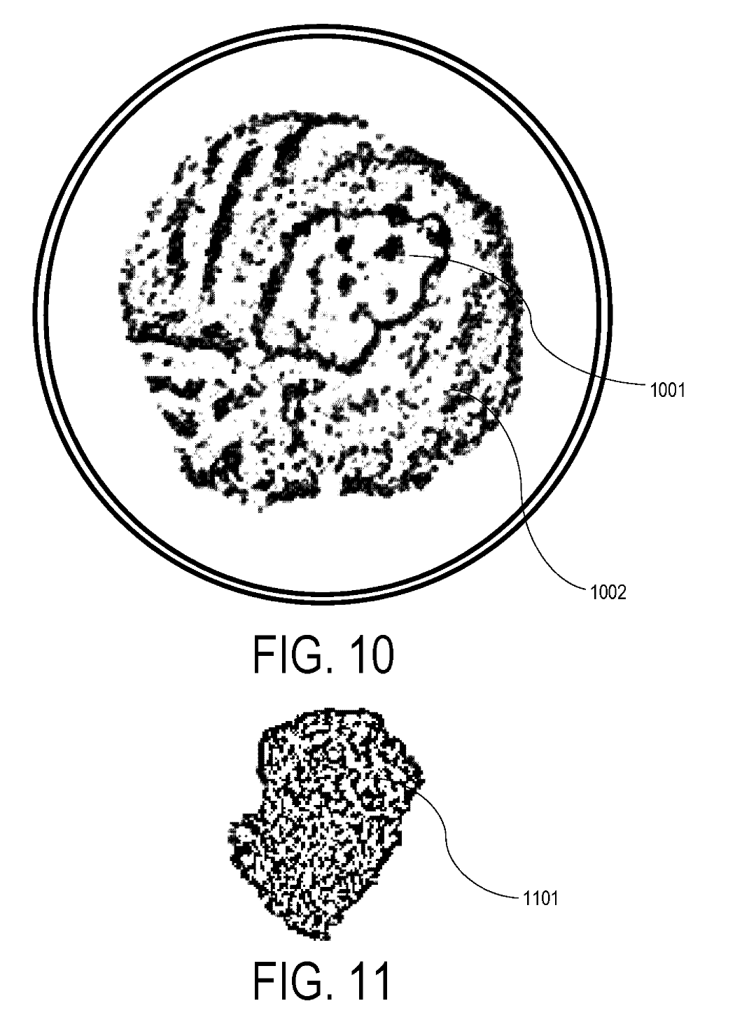

FIG. 10 shows the third step of the coating process, which involves covering the egg-bathed raw lobster slice 1001 produced by the step shown in FIG. 9, with a second carbohydrate, bread crumbs 1002. This is the final production step in the method of this exemplary embodiment.

FIG. 11 shows a detailed view of a multipurpose moisture-preserving raw lobster product 1101 produced by the step shown in FIG. 10, in one embodiment of the disclosure. Multipurpose moisture-preserving raw lobster product is a breaded 1101 (or other carbohydrate-coated) raw lobster tail slice that maximizes use and enjoyment of a single lobster tail by converting it into a plurality of breaded slices, generating multiple servings with generous “plate coverage” from a tail that would ordinarily yield only a single serving. For example, an 8-ounce (approximately 227-gram) tail might yield 20 slices. Further, the cost of each serving is reduced from that of a whole lobster tail, permitting lobster to become a more affordable product per serving. Additionally, lobster in the form of breaded raw lobster tail slices serves a variety of purposes beyond being a main course, as has traditionally been the case with lobster tail. Lobster tails that are 5 ounces (approximately 142 grams) are generally desirable to use due to the inability of smaller lobster tails to yield a sufficient number of slices to make processing economically sensible.

In one embodiment, several units of multipurpose moisture-preserving raw lobster product 1101 are sealed, packaged, and frozen. FIG. 12 shows an exemplary step of sealing frozen multipurpose moisture-preserving raw lobster product 1101 in a consumer retail package 1201. As shown in FIG. 13, the user (e.g., a quick-serve restaurant or home consumer) briefly pan-fries, without first defrosting, multipurpose moisture-preserving raw lobster product 1101 until a ready-to-eat, fully-cooked product 1301 is produced.

Countless uses for fully-cooked product 1301 are possible, including scaloppini-type recipes and other recipes that would normally include cutlets or other breaded cuts of meat or seafood. FIG. 14 shows fully-cooked product 1301 in one embodiment, on a plate 1401 for serving as an entrée. FIG. 15 shows fully-cooked product 1301 in another embodiment, in a sandwich 1501 along with tomatoes. End uses for a product consistent with embodiments of the disclosure include tenders, sandwiches, parmesan cutlets, tacos, and so forth.

In one embodiment, one or more additional steps of adding one or more other ingredients, such as dairy ingredients, may be employed. For example, a slice of lobster meat may be soaked in milk, buttermilk, or heavy cream prior to application of a sealing material. Alternatively, milk, buttermilk, or heavy cream may be added in a subsequent step, such as by mixing such ingredients with egg for use during the egg-bathing step.

In one embodiment, the multipurpose moisture-preserving raw lobster product is gluten-free.

In an alternative embodiment, one or more units of multipurpose moisture-preserving raw lobster product slices of lobster are cut into strip shapes or used whole. Then, a food glue, such as Ajinomoto Activa RM transglutaminase meat glue, is used to connect the ends of the strip together to form a ring, which can then be seasoned and coated with a carbohydrate and optionally frozen at that point, to create a product similar to a squid ring or onion ring.

Embodiments of the disclosure make lobster more accessible to the general public by making it cost effective to use, and by manufacturing/preparing the lobster in a new way that may be more acceptable to the consumer. Embodiments of the disclosure facilitate the serving of lobster by mainstream quick-serve restaurants (QSR) and make it financially-lucrative for QSR, retail, convenience, and fast-food operators to serve lobster.

Generally, source lobster meat for a recipe can either be purchased frozen or taken from a live lobster. The lobster meat can also be purchased cooked, usually in the form of steamed claw and knuckle meat, or as frozen raw tail meat, out of the shell. During cooking, the shell protects the lobster, because, out of the shell, raw lobster meat will shrink and become tough when exposed to direct and high heat.

Normally, the lobster shell protects the meat during the cooking process and keeps the meat tender and flavorful. It is difficult to cook raw lobster out of the shell and still maintain its integrity, especially in home-meal and fast-food service applications. Products consistent with embodiments of the disclosure maintain moisture despite absence of the lobster shell.

The term “breading,” as used herein, should be understood to include coating with any kind of carbohydrate or combination of carbohydrates and is not limited to bread or bread crumbs, or other flour-based ingredients.

Although the process of “sealing” a slice of lobster meat using a carbohydrate in embodiments of the disclosure generally involves coating the entire surface of the slice, in alternative embodiments, only a portion, or certain portions, of the slice may be covered by one or more carbohydrates. The term “sealing material,” as used herein, refers to any material applied to any portion of the surface of a slice of lobster meat to enhance moisture retention.

It should be understood that various changes in the details, materials, and arrangements of the parts which have been described and illustrated in order to explain the nature of this disclosure may be made by those skilled in the art without departing from the scope of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments.

Although the disclosure has been described using relative terms such as “front,” “back,” “side,” “top,” “bottom,” “over,” “above,” “under” and the like in the description and in the claims, such terms are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the disclosure.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Although the disclosure has been set forth in terms of the exemplary embodiments described herein and illustrated in the attached drawings, it is to be understood that such disclosure is purely illustrative and is not to be interpreted as limiting. Consequently, various alterations, modifications, and/or alternative embodiments and applications may be suggested to those skilled in the art after having read this disclosure. Accordingly, it is intended that the disclosure be interpreted as encompassing all alterations, modifications, or alternative embodiments and applications as fall within the true spirit and scope of this disclosure.

It will be further understood that various changes in the details, materials, and arrangements of the parts which have been described and illustrated in order to explain the nature of this disclosure may be made by those skilled in the art without departing from the scope of the disclosure as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

I claim:

1. A raw lobster product comprising:
a sealing material comprising at least one carbohydrate; and
an intact widthwise slice of raw lobster tail meat removed from a lobster tail and devoid of shell or exoskeleton, wherein:
the slice of raw lobster tail meat is compressed by application of force to have, relative to its state at the time of removal from the lobster tail, both (i) a reduced thickness and (ii) at least one of an increased length and an increased width; and
the sealing material covers at least a portion of the surface of the slice of raw lobster tail meat.

2. The raw lobster product of claim 1, wherein the application of force is by automated or manual extrusion.

3. The raw lobster product of claim 1, wherein the at least one carbohydrate is a starch.

4. The raw lobster product of claim 3, wherein the starch includes flour and bread crumbs bound to the slice of raw lobster tail meat with egg.

5. The raw lobster product of claim 1, wherein the sealing material covers the entire surface of the slice of raw lobster tail meat.

6. The raw lobster product of claim 1, wherein the slice of raw lobster tail meat is removed from the lobster tail by cutting at an angle of about 90 degrees relative to the cutting surface.

7. The raw lobster product of claim 1, wherein the slice of raw lobster tail meat is removed from the lobster tail by cutting at an angle of about 10 to 45 degrees relative to the cutting surface.

8. The raw lobster product of claim 1, wherein the slice of raw lobster tail meat is frozen.

9. The raw lobster product of claim 1, wherein the slice of raw lobster tail meat has been fried.

10. The raw lobster product of claim 1, wherein the lobster tail has been subjected to at least one high-pressure processing (HPP) technique prior removal of the slice of raw lobster tail meat.

11. A method for manufacturing a raw lobster product, the method comprising:
removing an intact widthwise slice of raw lobster tail meat from a lobster tail, wherein the slice of raw lobster tail meat is devoid of shell or exoskeleton;
compressing the slice of raw lobster tail meat by application of force to have, relative to its state at the time of removal from the lobster tail, both (i) a reduced thickness and (ii) at least one of an increased length and an increased width; and
covering at least a portion of the surface of the slice of raw lobster tail meat with a sealing material comprising at least one carbohydrate.

12. The method of claim 11, wherein the step of compressing the slice of raw lobster tail meat comprises applying force by automated or manual extrusion.

13. The method of claim 11, wherein the at least one carbohydrate is a starch.

14. The method of claim 13, wherein the starch includes flour and bread crumbs bound to the slice of raw lobster tail meat with egg.

15. The method of claim 11, wherein covering at least a portion of the surface of the slice of raw lobster tail meat with the sealing material comprises covering the entire surface of the slice of raw lobster tail meat with the sealing material.

16. The method of claim 11, wherein the step of removing the intact widthwise slice of raw lobster tail meat from the lobster tail comprises cutting at an angle of about 90 degrees relative to the cutting surface.

17. The method of claim 11, wherein the step of removing the intact widthwise slice of raw lobster tail meat from the lobster tail comprises cutting at an angle of about 10 to 45 degrees relative to the cutting surface.

18. The method of claim 11, further comprising freezing the slice of raw lobster tail meat.

19. The method of claim 11, further comprising frying the slice of raw lobster tail meat.

20. The method of claim 11, further comprising subjecting the lobster tail to at least high-pressure processing (HPP) technique prior to removing the slice of raw lobster tail meat.
